(19) United States
(12) Patent Application Publication
(10) Pub. No.: US 2025/0078830 A1
(43) Pub. Date: Mar. 6, 2025

(54) Adapter Finetuning with Teacher Pseudo-Labeling for Tail Languages in Streaming Multilingual ASR

(71) Applicant: Google LLC, Mountain View, CA (US)

(72) Inventors: Junwen Bai, Mountain View, CA (US); Bo Li, Fremont, CA (US); Qiujia Li, Mountain View, CA (US); Tara N. Sainath, Jersey City, NJ (US); Trevor Strohman, Mountain View, CA (US)

(73) Assignee: Google LLC, Mountain View, CA (US)

(21) Appl. No.: 18/826,743

(22) Filed: Sep. 6, 2024

Related U.S. Application Data
(60) Provisional application No. 63/580,977, filed on Sep. 6, 2023.

(51) Int. Cl. G10L 15/197; G10L 15/00; G10L 15/02; G10L 15/06; G10L 15/30

(52) U.S. Cl. CPC G10L 15/197; G10L 15/005; G10L 15/02; G10L 15/063; G10L 15/30

(57) ABSTRACT

A method includes receiving a sequence of acoustic frames characterizing a spoken utterance in a particular native language. The method also includes generating a first higher order feature representation for a corresponding acoustic frame in the sequence of acoustic frames by a causal encoder that includes an initial stack of multi-head attention layers. The method also includes generating a second higher order feature representation for a corresponding first higher order feature representation by a non-causal encoder that includes a final stack of multi-head attention layers. The method also includes receiving, as input at each corresponding language-dependent adapter (LDA) module, a language ID vector identifying the particular native language to activate corresponding language-dependent weights specific to the particular native language. The method also includes generating a first probability distribution over possible speech recognition hypotheses by a decoder.

### CROSS REFERENCE TO RELATED APPLICATIONS

This U.S. Patent Application claims priority under 35 U.S.C. § 119(e) to U.S. Provisional Application 63/580,977, filed on Sep. 6, 2023. The disclosure of this prior application is considered part of the disclosure of this application and is hereby incorporated by reference in its entirety.

### TECHNICAL FIELD

This disclosure relates to adapter finetuning with teacher pseudo-labeling for tail languages in streaming multilingual ASR.

### BACKGROUND

Automatic speech recognition (ASR), the process of taking an audio input and transcribing it into text, has greatly been an important technology that is used in mobile devices and other devices. In general, ASR attempts to provide accurate transcriptions of what a person has said by taking an audio input (e.g., speech utterance) and transcribing the audio input into text. Modern ASR models continue to improve in both accuracy (e.g., a low word error rate (WER) and latency (e.g., delay between the client speaking and the transcription) based on the ongoing development of deep neural networks. Despite a vast number of people being bilingual, most models are only compatible with a single language. Thus, an ASR model that is compatible with several different languages while still maintaining the accuracy and latency performance metrics of modern ASR models would be desirable for the vast number of bilingual speakers.

### SUMMARY

One aspect of the disclosure provides a streaming and non-streaming multilingual automated speech recognition (ASR) model. The ASR model includes a causal encoder including an initial stack of multi-head attention layers. The causal encoder is configured to receive a sequence of acoustic frames characterizing a spoken utterance in a particular native language as input and generate a first higher order feature representation for a corresponding acoustic frame in the sequence of acoustic frames at each of a plurality of output steps. The ASR model also includes a non-causal encoder including a final stack of multi-head attention layers overlain on the initial stack of multi-head attention layers. The non-causal encoder is configured to receive the first higher order feature representation generated by the causal encoder at each of the plurality of output steps as input and generate a second higher order feature representation for a corresponding first higher order feature representation, at each of the plurality of output steps. The ASR model also includes a plurality of language-dependent adapter (LDA) modules each including corresponding sets of language-dependent weights each specific to a different native language Each corresponding LDA module is inserted between two consecutive multi-head attention layers in the causal encoder or the non-causal encoder and is configured to receive, as input, a language ID vector identifying the particular native language to activate the corresponding language-dependent weights specific to the particular native language. The ASR model also includes a decoder configured to receive the second higher order feature representation generated by the non-causal encoder at each of the plurality of output steps as input and generate a probability distribution over possible speech recognition hypotheses in the particular native language at each of the plurality of output steps.

Implementations of the disclosure may include one or more of the following optional features. In some implementations, each corresponding multi-head attention layer subsequent to an initial multi-head attention layer in the initial stack of multi-head attention layers is configured to receive a concatenation of an output from a previous multi-head attention layer and output of the corresponding LDA module inserted between the corresponding multi-head attention layer and the previous multi-head attention layer. In some examples, the decoder is further configured to receive the first higher order feature representation generated by the causal encoder at each of the plurality of output steps as input and generate a second probability distribution over possible speech recognition hypotheses in the particular native language at each of the plurality of output steps. In these examples, the decoder may include: a prediction network configured to, at each of the plurality of output steps, receive a sequence of N previous non-blank symbols output by a final softmax layer as input, generate a respective embedding for each non-blank symbol of the sequence of N previous non-blank symbols, and generate an average embedding by averaging the respective embeddings; and a joint network configured to receive, as input, the average embedding generated by the prediction network at each of the plurality of output steps and one of the first higher order feature representation generated by the causal encoder at each of the plurality of output steps when the ASR model is operating in a streaming mode or the second higher order representation generated by the non-causal encoder at each of the plurality of output steps when the ASR model is operating in a non-streaming mode and generate the second probability distribution over possible speech recognition hypotheses when the ASR model is operating in the streaming mode or the probability distribution over possible speech recognition hypotheses when the ASR model is operating in the non-streaming mode. Here, the prediction network may include a V2 embedding look-up table.

In some implementations, the multi-head attention layers in the initial and the final stacks of multi-head attention layers include conformer layers. The initial stack of multi-head attention layers may include a greater number of multi-head attention layers than the final stack of multi-head attention layers. In some examples, a training process fine-tunes the corresponding language-dependent weights of the plurality of LDA modules while parameters of the causal encoder, the non-causal encoder, and the decoder are held fixed. The training process includes obtaining a plurality of training data sets each associated with a respective native language that is different than the respective native languages of the other training data sets and fine-tuning the corresponding set of language-dependent weights based only on the training data set that is associated with the respective particular native language for each of the plurality of LDA modules. Here, each training data set includes a plurality of respective training data samples, each training data sample includes audio data for an utterance spoken in the respective native language, a language identifier identifies the respective native language, and a corresponding transcription of the utterance in a respective native script represents the respective native language. Each multi-head attention layer in the initial and the final stacks of multi-head attention layers is followed by a corresponding LDA module. Each corresponding LDA module may further include a layernorm layer, a down-projection layer, a Rectified Linear Unit (ReLU) layer, an up-projection layer, and a residual connection.

Another aspect of the disclosure provides a computer-implemented method that when executed on data processing hardware causes the data processing hardware to perform operations for performing streaming multilingual speech recognition with LDA modules. The operations include receiving a sequence of acoustic frames characterizing a spoken utterance in a particular native language as input to a streaming and non-streaming multilingual automatic speech recognition (ASR) model. The operations also include generating, at each of a plurality of output steps, a first higher order feature representation for a corresponding acoustic frame in the sequence of acoustic frames by a causal encoder of the ASR model that includes an initial stack of multi-head attention layers. The operations also include generating, at each of the plurality of output steps, a second higher order feature representation for a corresponding first higher order feature representation by a non-causal encoder of the ASR model that includes a final stack of multi-head attention layers overlain on the initial stack of multi-head attention layers. The operations also include receiving a language ID vector as input at each corresponding language-dependent adapter (LDA) module of a plurality of LDA modules. Each corresponding LD module includes corresponding sets of language-dependent weights each specific to a different native language and is inserted between two consecutive multi-head attention layers in the causal encoder or the non-causal encoder. The language ID vector identifies the particular native language to activate the corresponding language-dependent weights specific to the particular native language. The operations also include, at each of the plurality of output, a first probability distribution over possible speech recognition hypotheses in the particular native language based on a corresponding second higher order feature representation generated the non-causal encoder by a decoder of the ASR model.

Implementations of the disclosure may include one or more of the following optional features. In some implementations, the operations further include receiving, as input at each corresponding multi-head attention layer subsequent to an initial multi-head attention layer in the initial stack of multi-head attention layers, a concatenation of an output from a previous multi-head attention layer and an output of the corresponding LDA module inserted between the corresponding multi-head attention layer and the previous multi-bead attention layer. In some examples, the operations further include generating, by the decoder and at each of the plurality of output steps, a second probability distribution over possible speech recognition hypotheses in the particular native language based on a corresponding first higher order feature representation generated by the causal encoder. In these examples, the operations may further include: generating, by a prediction network of the decoder and at each of the plurality of output steps, a respective embedding for each non-blank symbol of a sequence of N previous non-blank symbols output by a final softmax layer, generating, by a joint network of the decoder and at each of the plurality of output steps, the second probability distribution over possible speech recognition hypotheses based on the corresponding first higher order feature representation generated by the causal encoder when the ASR model is operating in a streaming mode; and generating, by the joint network and at each of the plurality of output steps, the probability over possible speech recognition hypotheses based on the corresponding second higher order feature representation generated by the non-causal encoder when the ASR model is operating in a non-streaming mode. Here, the prediction network may include a V2 embedding look-up table.

In some implementations, the multi-head attention layers in the initial and the final stacks of multi-head attention layers include conformer layers. The initial stack of multi-head attention layers may include a greater number of multi-head attention layers than the final stack of multi-head attention layers. In some examples, the operation further include a training process that fine-tunes the corresponding language-dependent weights of the plurality of LDA modules while parameters of the causal encoder, the non-causal encoder, and the decoder are held fixed. The training process includes obtaining a plurality of training data sets each associated with a respective native language that is different than the respective native languages of the other training data sets and fine-tuning the corresponding set of language-dependent weights based only on the training data set that is associated with the respective particular native language for each of the plurality of LDA modules. Here, each training data set includes a plurality of respective training data samples, each training data sample includes audio data for an utterance spoken in the respective native language, a language identifier that identifies the respective native language, and a corresponding transcription of the utterance in a respective native script that represents the respective native language. Each multi-head attention layer in the initial and the final stacks of multi-head attention layers is followed by a corresponding LDA module. Each corresponding LDA module may further include a layernorm layer, a down-projection layer, a Rectified Linear Unit (ReLU) layer, an up-projection layer, and a residual connection.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIG. 2 is a schematic view of an example streaming and non-streaming multilingual ASR model.

FIG. 3 is a schematic view of an example causal encoder or non-causal encoder.

FIG. 4 is a schematic view of an example language-dependent adapter (LDA) module.

FIG. 5 is a schematic view of an example training process for training the ASR model.

FIG. 6 is a flowchart of example arrangement of operations for a computer-implemented method of performing streaming multilingual speech recognition with LDA modules.

FIG. 7 is a schematic view of an example computing device that may be used to implement the systems and methods described herein.

Like reference symbols in the various drawings indicate like elements.

### DETAILED DESCRIPTION

End-to-end (E2E) automatic speech recognition (ASR) models are traditionally structured to operate in either a streaming mode or a non-streaming mode. Conventionally, an E2E ASR includes an encoder and a decoder as the main components. Applications that involve end-user interaction, like voice-search or on-device dictation, may require the model to perform recognition in a streaming fashion. Here, performing recognition in a streaming fashion refers to the ASR model outputting each word or word-piece of an utterance as they are spoken with as little latency as possible. Other applications, like offline video captioning, do not require the model to be streaming and can make use of future context to improve performance.

In some implementations, E2E ASR models are configured to recognize speech from multiple languages. Here, even though multilingual ASR models and language identification models are often used together in downstream tasks (e.g., code-switching and speech translation), the models are constructed and executed separately. As such, using both an independent multilingual ASR model and an independent language identification model needlessly complicates the overall ASR system by increasing computational and storage costs. However, training E2E ASR models to recognize speech from multiple languages is not an easy task as different languages have distinct vocabularies and varying levels of training data. Moreover, some ASR models may not have enough capacity to accommodate all of the different languages.

Accordingly, implementations herein are directed toward a streaming and non-streaming multilingual ASR model. The ASR model has a causal encoder, a non-causal encoder, a plurality of language-dependent adapter (LDA) modules, and a decoder. The causal encoder includes an initial stack of multi-head attention layers while the non-causal encoder includes a final stack of multi-head attention layers overlain on the initial stack of multi-head attention layers. The causal encoder is configured to generate a first higher order feature representation for a corresponding acoustic frame in a sequence of acoustic frames characterizing a spoken utterance in a particular native language. The non-causal encoder is configured to generate a second higher order feature representation for a corresponding first higher order feature representation. Each corresponding LDA module includes corresponding sets of language-dependent weights each specific to a different native language. Moreover, each corresponding LDA module is inserted between two consecutive multi-head attention layers in the causal encoder and/or the non-causal encoder. Each corresponding LDA module is configured to receive, as input, a language ID vector identifying the particular native language to activate the corresponding language-dependent weights specific to the particular native language. The decoder is configured to generate a probability distribution over possible speech recognition hypotheses fin the particular native language.

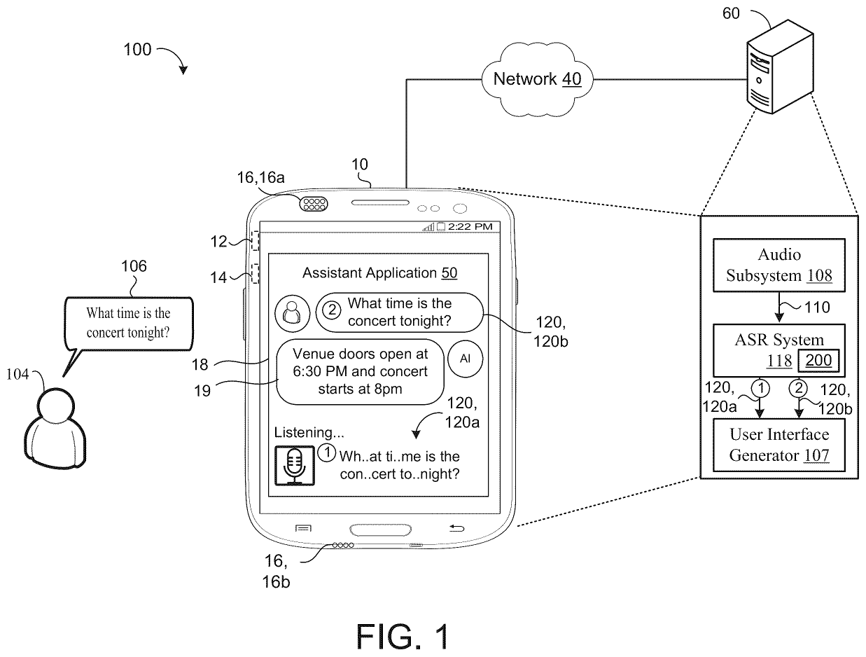

FIG. 1 is an example of a speech system 100. In the speech system 100, a user's 104 manner of interactive with a computing device, such as a user device 10, may be through voice input. The user device 10 (also referred to as a device 10) is configured to capture sounds (e.g., streaming audio data) from one or more users 104 within the speech system 100. Here, the streaming audio data may refer to a spoken utterance 106 by the user 104 that functions as an audible query, a command for the user device 10, or an audible communication captured by the user device 10. Speech-enabled systems of the user device 10 may field the query or the command by answering the query and/or causing the command to be performed/fulfilled by one or more downstream applications.

The user device 10 may correspond to any computing device associated with a user 104 and capable of receiving audio data. Some examples of user devices 10 include, but are not limited to, mobile devices (e.g., mobile phones, tablets, laptops, etc.), computers, wearable devices (e.g., smart watches), smart appliances, internet of things (IoT) devices, vehicle infotainment systems, smart displays, smart speakers, etc. The user device 10 includes data processing hardware 12 and memory hardware 14 in communication with the data processing hardware 12 and stores instructions, that when executed by the data processing hardware 12, causes the data processing hardware 12 to perform one or more operations. The user device 10 further includes an audio system 16 with an audio capture device (e.g., microphone) 16, 16a for capturing and converting spoken utterances 106 within the speech system 100 into electrical signals and a speech output device (e.g., a speaker) 16, 16b for communicating an audible audio signal (e.g., as output audio data from the user device 10). While the user device 10 implements a single audio capture device 16a in the example shown, the user device 10 may implement an array of audio capture devices 16a without departing from the scope of the present disclosure, whereby one or more capture devices 16a in the array may not physically reside on the user device 10, but be in communication with the audio system 16.

In the speech system 100, an automated speech recognition (ASR) system 118 implements an streaming and non-streaming multilingual ASR model 200 and resides on the user device 10 of the user 104 and/or on a remote computing device 60 (e.g., one or more remote servers of a distributed system executing in a cloud-computing environment) in communication with the user device 10 via a network 40. As will become apparent, the ASR model 200 may recognize speech in multiple different languages and operate in the streaming and non-streaming mode. In some examples, the ASR model 200 may be a recurrent neural network-transducer (RNN-T) model. The user device 10 and/or the remote computing device 60 also includes an audio subsystem 108 configured to receive the utterance 106 spoken by the user 104 and captured by the audio capture device 16a, and convert the utterance 106 into a corresponding digital format associated with input acoustic frames 110 capable of being processed by the ASR system 118. In the example shown, the user speaks a respective utterance 106 and the audio subsystem 108 converts the utterance 106 into corresponding audio data (e.g., sequence of acoustic frames) 110 for input to the ASR system 118. Thereafter, the ASR model 200 receives, as input, the sequence of acoustic frames 110 corresponding to the utterance 106, and generates/predicts, at each output step, a corresponding transcription 120 (e.g., speech recognition result/hypothesis) of the utterance 106 as the ASR model receives (e.g., processes) each acoustic frame 110 in the sequence of acoustic frames 110.

In the example shown, the ASR model 200 may perform streaming speech recognition to produce a first pass speech recognition hypothesis (e.g., initial speech recognition result) 120, 120a and generate a second pass speech recognition hypothesis (e.g., a final speech recognition result) 120, 120b by improving the first pass speech recognition hypothesis 120a. The first and second pass speech recognition hypotheses 120a, 120b may either correspond to a partial speech recognition result or an entire speech recognition result. Stated differently, the first and second pass speech recognition hypotheses 120a, 120b may either correspond a portion of an utterance 106 or an entire utterance 106. For example, the partial speech recognition result may correspond to a portion of a spoken utterance or even a portion of a spoken term. However, as will become apparent, the ASR model 200 performs additional processing on the second pass speech recognition hypothesis 120b whereby the second pass speech recognition hypothesis 120b may be delayed from the first pass speech recognition hypothesis 120a.

The user device 10 and/or the remote computing device 60 also executes a user interface generator 107 configured to present a representation of the transcription 120 of the utterance 106 to the user 104 of the user device 10. As described in greater detail below, the user interface generator 107 may display the first pass speech recognition hypothesis 120a in a streaming fashion during time 1 and subsequently display the second pass speech recognition hypothesis 120b in a streaming fashion during time 2. Notably, the ASR model 200 outputs the second pass speech recognition hypothesis 120b in a streaming fashion even though the second pass speech recognition hypothesis 120b improves upon the first pass speech recognition hypothesis 120a. In some configurations, the transcription 120 output from the ASR system 118 is processed, e.g., by a natural language understanding (NLU) module executing on the user device 10 or the remote computing device 60, to execute a user command/query specified by the utterance 106. Additionally or alternatively, a text-to-speech system (not shown) (e.g., executing on any combination of the user device 10 or the remote computing device 60) may convert the transcription 120 into synthesized speech for audible output by the user device 10 and/or another device.

In the example shown, the user 104 interacts with a program or application 50 (e.g., the digital assistant application 50) of the user device 10 that uses the ASR system 118. For instance, FIG. 1 depicts the user 104 communicating with the digital assistant application 50 and the digital assistant application 50 displaying a digital assistant interface 18 on a screen of the user device 10 to depict a conversation between the user 104 and the digital assistant application 50. In this example, the user 104 asks the digital assistant application 50, “What time is the concert tonight?” This question from the user 104 is a spoken utterance 106 captured by the audio capture device 16a and processed by audio systems 16 of the user device 10. In this example, the audio system 16 receives the spoken utterance 106 and converts it into a sequence of acoustic frames 110 for input to the ASR system 118.

Continuing with the example, the ASR model 200, while receiving the sequence of acoustic frames 110 corresponding to the utterance 106 as the user 104 speaks, encodes the sequence of acoustic frames 110 and then decodes the encoded sequence of acoustic frames 110 into the first pass speech recognition hypothesis 120a. During time 1, the user interface generator 107 presents, via the digital assistant interface 18, a representation of the first pass speech recognition hypothesis 120a of the utterance 106 to the user 104 of the user device 10 in a streaming fashion such that words, word pieces, and/or individual characters appear on the screen as soon as they are spoken. In some examples, the first look ahead audio context is equal to zero.

During time 2, the user interface generator 107 presents, via the digital assistant interface 18, a representation of the second pass speech recognition hypothesis 120b of the utterance 106 to the user 104 of the user device 10 a streaming fashion such that words, word pieces, and/or individual characters appear on the screen as soon as they are generated by the ASR model 200. In some implementations, the user interface generator 107 replaces the representation of the first pass speech recognition hypothesis 120a presented at time 1 with the representation of the second pass speech recognition hypothesis 120b presented at time 2. Here, time 1 and time 2 may include timestamps corresponding to when the user interface generator 107 presents the respective speech recognition result 120. In this example, the timestamp of time 1 indicates that the user interface generator 107 presents the first pass speech recognition hypothesis 120a at an earlier time than the second pass speech recognition hypothesis 120b. For instance, as the second pass speech recognition hypothesis 120b is presumed to be more accurate than the first pass speech recognition hypothesis 120a, the second pass speech recognition hypothesis 120b ultimately displayed as the transcription 120 may fix any terms that may have been misrecognized in the first pass speech recognition hypothesis 120a. In this example, the streaming first pass speech recognition hypothesis 120a output by the ASR model 200 are displayed on the screen of the user device 10 at time 1 are associated with low latency and provide responsiveness to the user 104 that his/her query is being processed, while the second pass speech recognition hypothesis 120b output by the ASR model 200 and displayed on the screen at time 2 leverages an additional speech recognition model and/or a language model to improve the speech recognition quality in terms of accuracy, but at increased latency. However, since the first pass speech recognition hypothesis 120a are displayed as the user speaks the utterance 106, the higher latency associated with producing, and ultimately displaying the second pass speech recognition hypothesis 120b is not noticeable to the user 104.

In the example shown in FIG. 1, the digital assistant application 50 may respond to the question posed by the user 104 using natural language processing Natural language processing generally refers to a process of interpreting written language (e.g., the first pass speech recognition hypothesis 120a and/or the second pass speech recognition hypothesis 120b) and determining whether the written language prompts any action. In this example, the digital assistant application 50 uses natural language processing to recognize that the question from the user 104 regards the user's schedule and more particularly a concert on the user's schedule. By recognizing these details with natural language processing, the automated assistant returns a response 19 to the user's query where the response 19 states, “Venue doors open at 6:30 PM and concert starts at 8 pm.” In some configurations, natural language processing occurs on a remote server 60 in communication with the data processing hardware 12 of the user device 10.

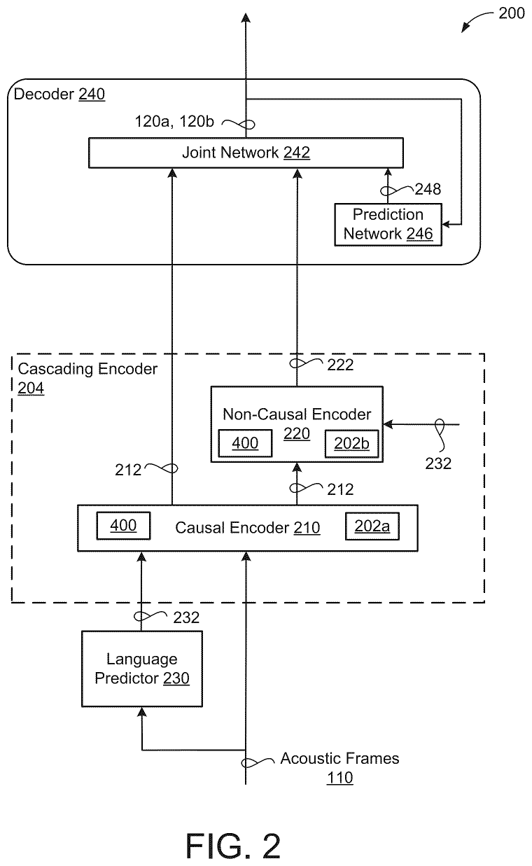

Referring now to FIG. 2, in some examples, the ASR model 200 includes a cascading encoder 204, a language predictor 230, and a decoder 240. The ASR model 200 may operate in a streaming mode, a non-streaming mode, and some combination thereof and process utterances in multiple different languages. The cascading encoder 204 refers to a model structure where the encoding pathway includes two encoders 210, 220 that cascade such that the output of a first encoder (i.e., causal encoder) 210 feeds the input of a second encoder (i.e., non-causal encoder) 220 prior to decoding. Here, the first encoder 210 and the second encoder 220 may be cascaded irrespective of the underlying architecture of each encoder. The encoders 210, 220 may each include a stack of multi-headed (e.g., 8 heads) attention layers 202a. In some examples, the stack of multi-headed attention layers of the encoders 210, 220 includes a stack of 512-dimension of conformer layers. In other examples, transformer layers may be used in lieu of conformer layers. Moreover, the encoder 210, 220 may include a plurality of language-dependent adapter (LDA) modules 400 each inserted between two consecutive multi-head attention layers 202 in the causal encoder 210 or the non-causal encoder 220.

The first encoder 210 may be a causal encoder that includes 17 conformer layers each with a multi-headed (e.g., 8 heads) attention mechanism used as a self-attention layer. Moreover, each conformer layer of the first encoder 210 may use causal convolution and left-context attention layers to restrict the first encoder from using any future inputs (e.g., right-context equal to zero) The first encoder 210 may include an initial stack of multi-head attention layers 202, 202a from the stack of multi-head attention layers 202. On the other hand, the second encoder 220 may be a non-causal encoder that includes 4 conformer layers each with a multi-headed (e.g., 8 heads) attention mechanism used as a self-attention layer. Each conformer layer of the second encoder may use non-causal convolution and right-context attention layers thereby allowing the second encoder 220 to use (e.g., attend to) future inputs. That is, the second encoder 220 may receive and process additional right-context (e.g., 2.88 seconds) to generate an encoder output. The second encoder 220 may include a final stack of multi-head attention layers 202, 202b from the stack of multi-head attention layers 202. For example, the cascading encoder 204 may include a stack of ten (10) multi-head attention layers 202 whereby the causal encoder 210 includes the initial stack of three (3) multi-head attention layers 202a and the non-causal encoder 220 includes the final stack of seven (7) multi-head attention layers 202b.

The language predictor 230 is configured to predict a language identification (ID) vector 232 by processing the sequence of acoustic frames 110. That is, since the ASR model 200 recognizes speech from multiple different languages, the language predictor 230 processes the sequence of acoustic frames 110 to predict the language ID vector 232 that identifies a particular native language that an utterance 106 was spoken in. For example, the language ID vector 232 may indicate English for an utterance spoken in the English language or may indicate Spanish for an utterance spoken in the Spanish language. In another example, the language ID vector 232 may indicate one or more particular native languages for each acoustic frame 110 in the sequence of acoustic frames 110. That is, the spoken utterance 106 may be a code-switch utterance that includes multiple different languages in the same utterance spoken by a same speaker. Here, the language ID vector 232 indicates each of the multiple different native languages corresponding to each acoustic frame 110 in the sequence of acoustic frames 110. The language predictor 230 output the language ID vector 232 to the causal encoder 210 and the non-causal encoder 210. In some configurations, each LDA module 400 of the causal encoder 210 and the non-causal encoder 220 receives the language ID vector 232 from the language predictor 230.

With continued reference to FIG. 2, the first encoder 210 receives a sequence of d-dimensional feature vectors (e.g., sequence of acoustic frames 110) x=(x₁, x₃, . . . , x_{T}), where xₜ∈ [symbol] ^{d}, and generates, at each output step of a plurality of output steps, a first higher order feature representation 212 for a corresponding acoustic frame 110 in the sequence of acoustic frames 110. The first encoder 210 may generate the first higher order feature representation 212 based on the corresponding acoustic frame 110 and/or the language ID vector 232. Similarly, the second encoder 220 is connected in cascade to the first encoder 210, and receives the first higher-order feature representation 212 as input, and generates, at each output step, a second higher order feature representation 222 for a corresponding first higher order feature representation (e.g., initial sequence of audio encodings) 212. The second encoder 220 may generate the second higher order feature representation 222 based on the corresponding first higher order feature representation 210 and/or the language ID vector 232. Notably, the second encoder 220 attends to additional right-context to generate each second higher order feature representation (e.g., subsequent sequence of audio encodings) 222. However, in some instances, the second encoder 220 generates the second higher order feature representations 222 without receiving any of the acoustic frames 110 as input. In these instances, the second encoder 220 generates the second higher order feature representations 222 using only the first higher order feature representation 212 as input. The cascading encoder 204 may operate in a streaming fashion such that, at each output step, the cascading encoder 204 generates the first and second higher order feature representations 212, 222 that correspond to either a portion of an utterance or an entire utterance.

In some examples, the decoder 240 includes a transducer decoder. The decoder 240 may include a recurrent neural network-transducer (RNN-T) architecture having a joint network 242 and a prediction network 246. In some examples, the decoder 240 includes a final softmax output layer (not shown). The decoder 240 uses the joint network 232 to combine the first higher order feature representation 212 output by the first encoder 210 and an average embedding 248 output from the prediction network 246 to generate a decoder output. That is, when the ASR model 200 is operating in the streaming mode, the joint network 242 is configured to receive, as input, the average embedding (i.e., dense representation) 248 output from the prediction network 246 and the first higher order feature representation 212 generated by the first encoder 210 and generate, at each output step, a first probability distribution 120, 120b over possible speech recognition hypotheses in the particular native language. Here, the first probability distribution 120b is based on the average embedding 248 and the first higher order feature representation 212. On the other hand, when the ASR model is operating in the non-streaming mode, the joint network 242 is configured to receive, as input, the average embedding (i.e., dense representation) 248 output from the prediction network 246 and the second higher order feature representation 222 generated by the first encoder 210 and generate, at each output step, a second probability distribution 120, 120a over possible speech recognition hypotheses in the particular native language. Here, since the second encoder 220 generates the second higher order feature representation 222 by processing additional right-context, the second probability distribution 120a improves upon the first probability distribution 120b.

Although not illustrated, the decoder 240 may include a final softmax layer that receives the output of the decoder 240. In some implementations, the softmax layer is separate from the decoder 240 and processes the output from the decoder 240. In other implementations, the softmax layer is integrated with the decoder 240 and processes the output from the joint network 242. The output of the softmax layer is then used in a beam search process to select orthographic elements.

In some implementations, the probability distributions 120a, 120b output by the decoder 240 include a speech recognition results 120. As such, the first and second speech recognition results 120a, 120b may be used interchangeable with the first and second probability distributions 120a, 120b over possible speech recognition hypotheses. Thus, the joint network 242 may generate, at each output step (e.g., time step), a probability distribution 120 over possible speech recognition hypotheses. Here, the “possible speech recognition hypotheses” correspond to a set of output labels/symbols (also referred to as “speech units”) each representing a grapheme (symbol/character) or a word piece in a specified natural language. For example, when the natural language is English, the set of output labels may include twenty-seven (27) symbols, e.g., one label for each of the 26-letters in the English alphabet and one label designating a space. Accordingly, the joint network 242 may output a set of values indicative of the likelihood of occurrence of each of a predetermined set of output labels. The set of values can be a vector (e.g., a one-hot vector) and can indicate a probability distribution over the set of output labels. In some scenarios, the output labels are graphemes (e g., individual characters, and potentially punctuation and other symbols), but the set of output labels is not so limited. For example, the set of output labels can include wordpieces and/or entire words, in addition to or instead of graphemes. The output labels could also be other types of speech units, such as phonemes or subphonemes. The probability distribution 120 output by the joint network 240 can include a posterior probability value for each of the different output labels. Thus, if there are 100 different output labels representing different graphemes or other symbols, the output of the joint network 240 can include 100 different probability values, one for each output label. The probability distribution 120 can then be used to select and assign scores to candidate orthographic elements (e.g., graphemes, wordpieces, and/or words) in a beam search process (e.g., by a final Softmax layer of the second joint network 250b (not shown)) for determining the speech recognition result 120. For example, the joint network 240 may select the N-best possible speech recognition hypotheses having the highest probabilities as output for the speech recognition result 120.

The decoder 240 may include a transducer decoder architecture. Within the decoder 240, the prediction network 246 may have two 2,048-dimensional LSTM layers, each of which is also followed by a 640-dimeinsinal projection layer. In some examples, the prediction network 246 includes a V2 embedding look-up table. The prediction network 246 receives, as input, a sequence of non-blank symbols output by the final Softmax layer of the joint network 242 and generates, at each output step, a dense representation (i.e., average embedding) 248. More specifically, the prediction network 246 generates a respective embedding for each non-blank symbol of the sequence of N previous non-blank symbols and generates the average embedding by averaging the respective embeddings. The joint network 242 receives the average embedding 248 for the previous acoustic frame 110 in the sequence of acoustic frames 110 and generates a subsequent probability distribution 120 using the average embedding 248.

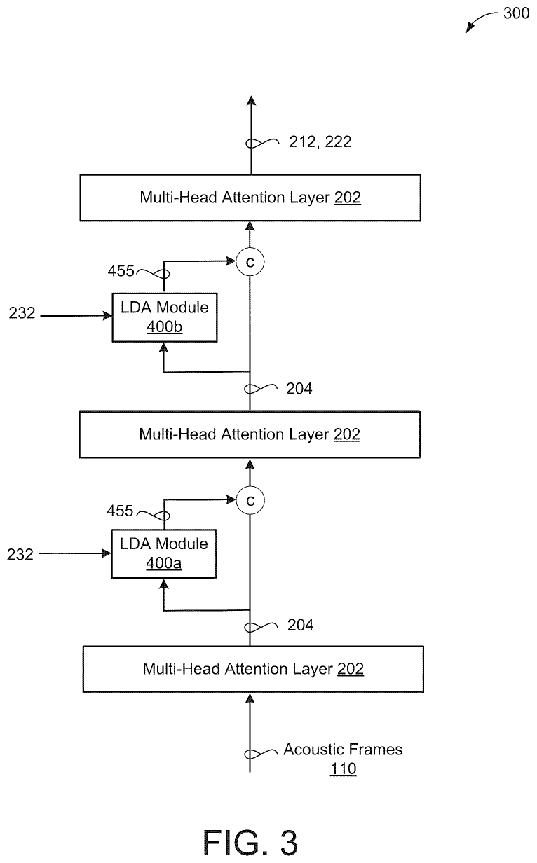

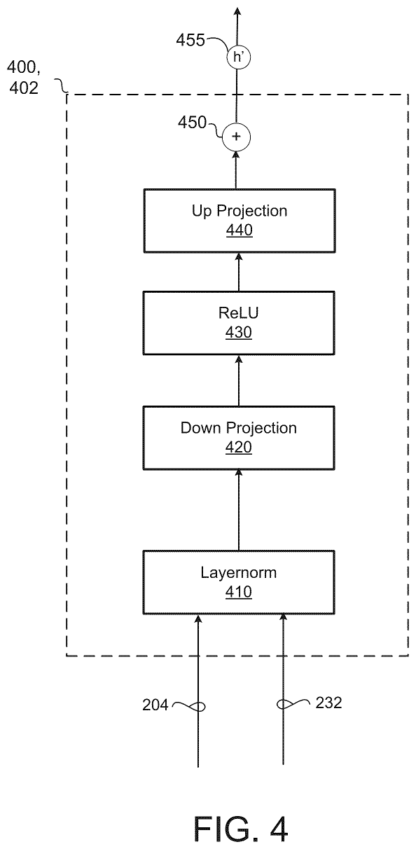

As such, the ASR model 200 may operate in a streaming mode by generating the probability distribution 120 based on the first higher order feature representations 212 and/or operate in a non-streaming mode by generate the probability distribution based on the second higher order feature representation 222. Moreover, the ASR model 200 may recognize speech from multiple different native languages whereby the language predictor 232 generate the language ID vector 232 to indicate to the ASR model 200 which particular native language was spoken for the sequence of acoustic frames 110. Since the causal encoder 210 does not process additional right context and the non-causal encoder 220 does process additional right context, probability distributions 120 generated from the second higher order feature representations 222 improve upon the probability distributions 120 generate from the first higher order feature representations 212. Discussed in greater detail with reference to FIGS. 3 and 4, the first encoder 210 may include the initial stack of multi-head attention layers 202a (e.g, conformer layers) and one or more LDA modules 400 and the second encoder 220 may include the final stack of multi-head attention layers 202b (e.g., conformer layers) and one or more LDA modules 400.

FIG. 3 shows a schematic view 300 of an example stack of multi-head attention layers 202 corresponding to the first encoder 210 and/or second encoder 220. Thus, the example stack of multi-head attention layers 202 may correspond to the initial stack of multi-head attention layers 202a (FIG. 2) or the final stack of multi-head attention layers 202b (FIG. 2) overlain on the initial stack of multi-head attention layers 202a. In the example shown, the stack of multi-head attention layers 202 includes three (3) multi-head attention layers for the sake of clarify only, as it is understood that the stack of multi-head attention layers 202 may include any number of multi-head attention layers 202. In some examples, the initial stack of multi-head attention layers 202a includes a greater number of multi-head attention layers 202 than the final stack of multi-head attention layers 202b. In some configurations, each multi-head attention layer 202 in the initial and the final stacks of multi-head attention layers 202 is followed by a corresponding LDA module 400 from the plurality of LDA modules 400. In other configurations, each multi-head attention layer 202 is followed by the corresponding LDA module 400 except for the final multi-head attention layer 202 in the initial stack of multi-head attention layers 202a and/or the final stack of multi-head attention layers 202b. Accordingly, each corresponding LDA module 400 is inserted between two consecutive multi-head attention layers 202 in the causal encoder 210 or the non-causal encoder 220. For instance, in the example shown, a first LDA module 400, 400a is inserted between a first and second multi-head attention layer 202 and a second LDA module 400, 400b is inserted between the second and third multi-head attention layer 202.

With continued reference to FIG. 3, the initial multi-head attention layer 202 in the stack of multi-head attention layers 202 processes the sequence of acoustic frames to generate an encoder output 204. Although not illustrates, the initial multi-head attention layer 202 in the final stack of multi-head attention layers 202 processes the first higher order feature representation 212 generated by the first encoder 210 (FIG. 2) in addition to, or in lieu of, processing the sequence of acoustic frames 110 to generate the encoder output 204. Each corresponding multi-head attention layer 202 subsequent to an initial multi-head attention layer 202 in the initial stack of multi-head attention layers 202a and/or the final stack of multi-head attention layers 202b is configured to receive a concatenation of an encoder output 204 from a previous multi-head attention layer 202 and output 455 of the corresponding LDA module 400 inserted between the corresponding multi-head attention layer 202 and the previous multi-head attention layer 202. Thus, each corresponding multi-head attention layer 202 subsequent to the initial multi-head attention layer 202 in the initial stack of multi-head attention layers 202a is configured to generate the encoder output 204 or the first or second higher order feature representation 212, 222 based on the received concatenation. In the example shown, the first multi-head attention layer 202 generates the encoder output 204 by processing a corresponding acoustic frame 110 in the sequence of acoustic frames 110 which is fed to the first LDA module 400a that generates the output 455 that is concatenated with the encoder output 204 and fed to the subsequent (i.e., second) multi-head attention layer 202. Thereafter, the second multi-head attention layer 202 processes the concatenation to generate the encoder output 204 which is fed to the second LDA module 400b that generates the output 455 that is concatenated with the encoder output 204 and fed to the subsequent (i.e., third and final) multi-head attention layer 202. The Third multi-head attention layer 202 processes the concatenation to generate the first higher order feature representation 212 or the second higher order feature representation 222. Moreover, the LDA modules 400 may receive the language ID vector 232 such that the LDA module generates the output 455 further based on the language ID vector 232 in addition to the encoder output 204.

FIG. 4 illustrates an example LDA module 400 of the plurality of LDA modules 400. Each LDA module 400 includes corresponding sets of language-dependent weights 402 each specific to a different native language. As such, each corresponding LDA module 400 is configured to receive, as input, the language ID vector 232 as input that identifies the particular native language of the sequence of acoustic frames 110 to activate the corresponding language-dependent weights 402 specific to the particular native language. Here, the LDA module 400 may activate the corresponding language-dependent weights 402 specific to the particular native language based on the language ID vector 232. Activating the corresponding language-dependent weights 402 specific to the particular native language may include deactivating the language-dependent weights 402 that are not specific to the particular native language. As such, only the language-dependent weights 402 specific to the particular native language of the sequence of acoustic frames 110 may be active when processing the input to the LDA module 400. In configurations where the sequence of acoustic frames 110 corresponds to multiple different languages (e.g., code-switched utterance) language-dependent weights specific to each of the multiple languages are activated while language-dependent weights not specific to any of the multiple language are deactivated.

The LDA module 400 may include a layernorm layer 410, a down-projection layer 420, a Rectified Linear Unit (ReLU) layer 430, an up-projection layer 440 and a residual connection 450. In some implementations the LDA module 400 receives an input corresponding to the encoder output 204 from the previous multi-head attention layer 202 and/or the language ID vector 232. The LDA module 400 then processes the input through the components 410, 420, 430, 440, and/or 450 to produce an output 455.

In some implementations, to adapt the ASR model 200 to new languages, the ASR model 200 may be adapted with the LDA modules 400. The LDA modules 410 may include lightweight neural modules which are inserted between layers of the first encoder 210 and/or the second encoder 220. As illustrated in FIG. 4, each LDA module 400 may apply later normalization to a d dimensional input vector followed by down projecting to a bottleneck dimension r with down projection, a ReLU activation, an up projection, and a residual connection from the input to the output of the up projection.

The LDA module 400 may generate the output 455 according to:

x′ᵢ=Uₓ(ReLU(Dₓ(LN(xᵢ₋₁))))+xᵢ₋₁ (1)

The LDA modules 400 may be inserted anywhere into the ASR model 200. In some implementations, the LDA modules 400 are most effective being inserted in between conformer layers of the first encoder 210 and/or the second encoder 220. In some implementations, the down-projection 420 and/or the up-projection 440 receive a biasing term and generate their outputs further based on the biasing term.

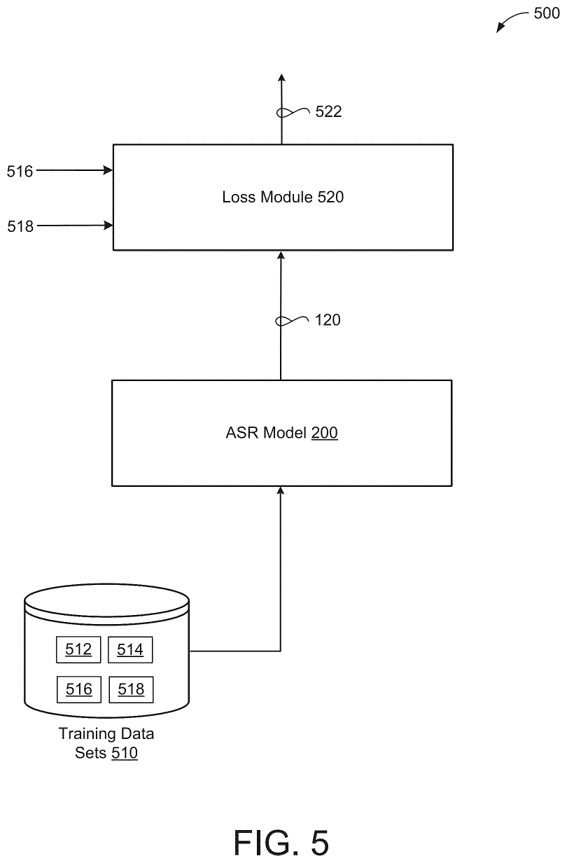

FIG. 5 illustrates a training process 500 that fine-tunes the corresponding language-dependent weights 402 of the plurality of LDA modules 400 while parameters of the causal encoder 210, the non-causal encoder 220, and the decoder 240 are held fixed (i.e., frozen). The training process 500 includes obtaining a plurality of training data sets 510 each associated with a respective native language that is different than the respective native languages of the other training data sets 510. Each training data set 510 includes a plurality of respective training data samples 512. Each training data sample 512 includes audio data 514 for an utterance spoken in the respective native language, a language identifier 516 identifying the respective native language, and a corresponding transcription 518 of the utterance in a respective native script representing the respective native language. For example, a first training data set 510 may include training data samples 512 in English with audio data 514 of utterances spoken in English, the language identifier 516 identifying the English language, and a corresponding transcription 518 of the utterances in a native script representing the English language. Similarly, a second training data set 510 may include training data samples 512 in Spanish with audio data 514 of utterances spoken in Spanish, the language identifier 516 identifying the Spanish language, and a corresponding transcription 518 of the utterances in a native script representing the Spanish language.

With continued reference to FIG. 5, the ASR model 200 generates speech recognition results 120 for each training data sample 512 in each training data set 510. This may include generating first speech recognition results 120a and/or second speech recognition results 120b. Moreover, the ASR model 200 may generate the speech recognition results 120 as described in FIGS. 2-4. More specifically, the ASR model 200 may predict the language of each training data sample 512 and activate the corresponding set of language-dependent weights 402 of each LDA module 400 based on the prediction such that the ASR model generates the speech recognition result 120 with only the activated corresponding set of language-dependent weights 402. A loss module 520 may receive the speech recognition results 120 generated by the ASR model 200 and compare the speech recognition results 120 to the transcription 518 that corresponds to the training data sample 512 the speech recognition result 120 was generated from. Based on the comparison, the loss module 520 may generate a loss 522. In some examples, the loss module 520 compares each of the first speech recognition result 120a and the second speech recognition result 120b to the transcription 518 such that the loss 522 has a first component and a second component. Moreover, the loss module 520 may determined the loss 522 based on the language identifier 516 identifying the respective native language of the training data sample 512.

Thereafter, the training process 500 may fine-tune the corresponding set of language dependent weights 402 based only on the training data set 510 that is associated with the particular native language. As such, only the training data set 510 associated with the corresponding set of language-dependent weights 402 are used to train the LDS module 400. For example, the LDA modules 400 may include a first set of language dependent weights 402 associated with English and a second set of language dependent weights 402 associate with Spanish. Moreover, the training data sets 510 may include a first set associated with English utterances and a second set associated with Spanish utterances. As such, the training process 500 only fine-tunes the first set of language dependent weights using the English utterances an fine-tunes the second set of language dependent weights 402 using the Spanish utterances. As such, each utterance only updates a specific portion of the LDA modules 400 without interfering with the other languages.

In some implementations, after the training process 500 fine-tunes the ASR model 200 on all of the training data, the training process 500 selects peak checkpoints with the best accuracy (e.g., WER performance) on each locale or language. Since the LDA modules 400 all share the same foundational model weights of the ASR model 200, the training process 500 extracts the language-dependent weights 402 from those checkpoints and merges the language-dependent weights to generate the final LDA module 402. That is, at each of a plurality of checkpoints during training, the training process 500 may extract the language-dependent weights for each respective language with the best accuracy and use the extracted language-dependent weights for each language. Notably, the training process 500 fine-tunes the corresponding language-dependent weights of the plurality of LDA modules 400 while parameter of the causal encoder 210, the non-causal encoder 220, and the decoder 240 are held fixed (i.e., are not fine-tuned are otherwise updated).

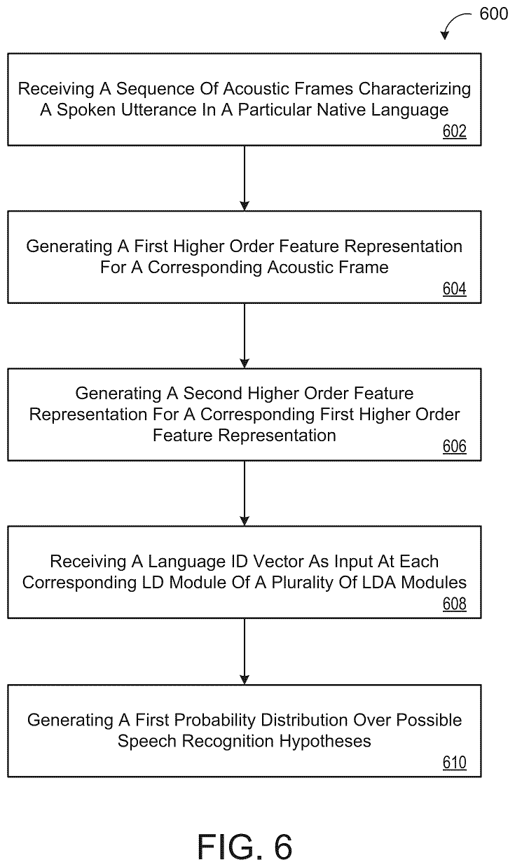

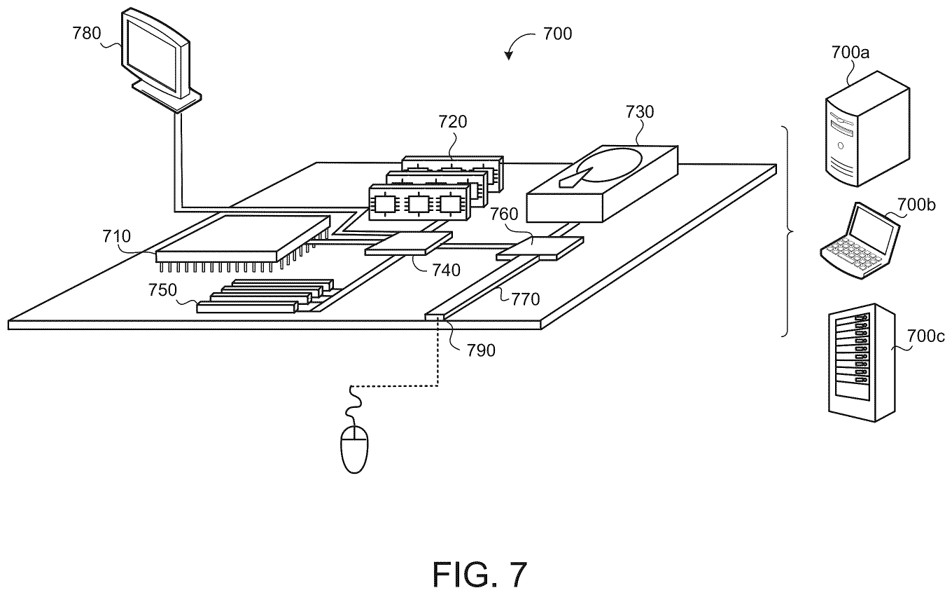

FIG. 6 is a flowchart of an example arrangement of operations for a computer-implemented method 600 of performing streaming multilingual speech recognition with LDA modules. The method 600 may execute on data processing hardware 710 (FIG. 7) using instructions stored on memory hardware 720 (FIG. 7). The data processing hardware 710 and the memory hardware 720 may reside on the user device 10 and/or the remote computing device 60 each corresponding to a computing device 700 (FIG. 7).

At operation 602, the method 600 includes receiving a sequence of acoustic frames 110 characterizing a spoken utterance 106 in a particular native language as input to an ASR model 200. At operation 604, the method 600 includes generating, at each of a plurality of output steps, a first higher order feature representation 212 for a corresponding acoustic frame 110 in the sequence of acoustic frames 110 by a causal encoder 210 of the ASR model 200. The causal encoder 210 includes an initial stack of multi-head attention layers 202a. At operation 606, the method 600 includes generating, at each of the plurality of output steps, a second higher order feature representation 222 for a corresponding first higher order feature representation 212 by a non-causal encoder 220 of the ASR model 200. The non-causal encoder includes a final stack of multi-head attention layers 202b overlain on the initial stack of multi head attention layers 202a. At operation 608, the method 600 includes receiving a language ID vector 232 as input at each corresponding LDA module 400 of a plurality of LDA modules 400. Each corresponding LDA module 400 includes corresponding sets of language-dependent weights 402 each specific to a different native language and is inserted between two consecutive multi-head attention layers 202 in the causal encoder 210 or the non-causal encoder 220. The language ID vector 232 identifies the particular native language to activate the corresponding language-dependent weights 402 specific to the particular native language. At operation 610, the method 600 includes generating, by a decoder 240 of the ASR model 200, at each of the plurality of output steps, a first probability distribution 120b over possible speech recognition hypotheses in the particular native language based on a corresponding second higher order feature representation 212 generated by the non-causal encoder 220.

FIG. 7 is a schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g, as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A streaming and non-streaming multilingual automated speech recognition (ASR) model, the ASR model comprising:
a causal encoder comprising an initial stack of multi-head attention layers, the causal encoder configured to:
receive, as input, a sequence of acoustic frames characterizing a spoken utterance in a particular native language; and
generate, at each of a plurality of output steps, a first higher order feature representation for a corresponding acoustic frame in the sequence of acoustic frames;
a non-causal encoder comprising a final stack of multi-head attention layers overlain on the initial stack of multi-head attention layers, the non-causal encoder configured to:
receive, as input, the first higher order feature representation generated by the causal encoder at each of the plurality of output steps; and
generate, at each of the plurality of output steps, a second higher order feature representation for a corresponding first higher order feature representation;
a plurality of language-dependent adapter (LDA) modules each comprising corresponding sets of language-dependent weights each specific to a different native language, wherein each corresponding LDA module:
is inserted between two consecutive multi-head attention layers in the causal encoder or the non-causal encoder; and
configured to receive, as input, a language ID vector identifying the particular native language to activate the corresponding language-dependent weights specific to the particular native language; and
a decoder configured to:
receive, as input, the second higher order feature representation generated by the non-causal encoder at cach of the plurality of output steps; and
generate, at each of the plurality of output steps, a probability distribution over possible speech recognition hypotheses in the particular native language.

2. The ASR model of claim 1, wherein each corresponding multi-head attention layer subsequent to an initial multi-head attention layer in the initial stack of multi-head attention layers is configured to receive a concatenation of an output from a previous multi-head attention layer and output of the corresponding LDA module inserted between the corresponding multi-head attention layer and the previous multi-head attention layer.

3. The ASR model of claim 1, wherein the decoder is further configured to:
receive, as input, the first higher order feature representation generated by the causal encoder at each of the plurality of output steps; and
generate, at each of the plurality of output steps, a second probability distribution over possible speech recognition hypotheses in the particular native language.

4. The ASR model of claim 3, wherein the decoder comprises:
a prediction network configured to, at each of the plurality of output steps:
receive, as input, a sequence of N previous non-blank symbols output by a final softmax layer;
for each non-blank symbol of the sequence of N previous non-blank symbols, generate a respective embedding; and
generate an average embedding by averaging the respective embeddings; and
a joint network configured to:
receive, as input, the average embedding generated by the prediction network at each of the plurality of output steps and one of:
when the ASR model is operating in a streaming mode, the first higher order feature representation generated by the causal encoder at each of the plurality of output steps; or
when the ASR model is operating in a non-streaming mode, the second higher order representation generated by the non-causal encoder at each of the plurality of output steps; and
generate, at each of the plurality of output steps, one of:
when the ASR model is operating in the streaming mode, the second probability distribution over possible speech recognition hypotheses; or
when the ASR model is operating in the non-streaming mode, the probability distribution over possible speech recognition hypotheses.

5. The ASR model of claim 4, wherein the prediction network comprises a V2 embedding look-up table.

6. The ASR model of claim 1, wherein the multi-head attention layers in the initial and the final stacks of multi-head attention layers comprise conformer layers.

7. The ASR model of claim 1, wherein the initial stack of multi-head attention layers comprises a greater number of multi-head attention layers than the final stack of multi-head attention layers.

8. The ASR model of claim 1, wherein a training process fine-tunes the corresponding language-dependent weights of the plurality of LDA modules while parameters of the causal encoder, the non-causal encoder, and the decoder are held fixed, the training process comprising:
obtaining a plurality of training data sets each associated with a respective native language that is different than the respective native languages of the other training data sets, each training data set comprising a plurality of respective training data samples, each training data sample comprising audio data for an utterance spoken in the respective native language, a language identifier identifying the respective native language, and a corresponding transcription of the utterance in a respective native script representing the respective native language; and
for each of the plurality of LDA modules, fine-tuning the corresponding set of language-dependent weights based only on the training data set that is associated with the respective particular native language.

9. The ASR model of claim 1, wherein each multi-head attention layer in the initial and the final stacks of multi-head attention layers is followed by a corresponding LDA module.

10. The ASR model of claim 1, wherein each corresponding LDA module further comprises:
a layernorm layer;
a down-projection layer;
a Rectified Linear Unit (ReLU) layer;
an up-projection layer; and
a residual connection.

11. A computer-implemented method executed on data processing hardware that causes the data processing hardware to perform operations comprising:
receiving, as input to a streaming and non-streaming multilingual automatic speech recognition (ASR) model, a sequence of acoustic frames characterizing a spoken utterance in a particular native language;
generating, by a causal encoder of the ASR model comprising an initial stack of multi-head attention layers, at each of a plurality of output steps, a first higher order feature representation for a corresponding acoustic frame in the sequence of acoustic frames;
generating, by a non-causal encoder of the ASR model comprising a final stack of multi-head attention layers overlain on the initial stack of multi-head attention layers, at each of the plurality of output steps, a second higher order feature representation for a corresponding first higher order feature representation;
receiving, as input at each corresponding language-dependent adapter (LDA) module of a plurality of LDA modules, a language ID vector, each corresponding LDA module comprising corresponding sets of language-dependent weights each specific to a different native language and is inserted between two consecutive multi-head attention layers in the causal encoder or the non-causal encoder, the language ID vector identifying the particular native language to activate the corresponding language-dependent weights specific to the particular native language; and
generating, by a decoder of the ASR model, at each of the plurality of output steps, a first probability distribution over possible speech recognition hypotheses in the particular native language based on a corresponding second higher order feature representation generated the non-causal encoder.

12. The computer-implemented method of claim 11, wherein the operations further comprise receiving, as input at each corresponding multi-head attention layer subsequent to an initial multi-head attention layer in the initial stack of multi-head attention layers, a concatenation of an output from a previous multi-head attention layer and an output of the corresponding LDA module inserted between the corresponding multi-head attention layer and the previous multi-head attention layer.

13. The computer-implemented method of claim 11, wherein the operations further comprise generating, by the decoder, at each of the plurality of output steps, a second probability distribution over possible speech recognition hypotheses in the particular native language based on a corresponding first higher order feature representation generated by the causal encoder.

14. The computer-implemented method of claim 13, wherein the operations further comprise:
for each non-blank symbol of a sequence of N previous non-blank symbols output by a final softmax layer, generating, by a prediction network of the decoder, at each of the plurality of output steps, a respective embedding;
when the ASR model is operating in a streaming mode, generating, by a joint network of the decoder, at each of the plurality of output steps, the second probability distribution over possible speech recognition hypotheses based on the corresponding first higher order feature representation generated by the causal encoder; and
when the ASR model is operating in a non-streaming mode, generating, by the joint network, at each of the plurality of output steps, the probability over possible speech recognition hypotheses based on the corresponding second higher order feature representation generated by the non-causal encoder.

15. The computer-implemented method of claim 14, wherein the prediction network comprises a V2 embedding look-up table.

16. The computer-implemented method of claim 11, wherein the multi-head attention layers in the initial and the final stacks of multi-head attention layers comprise conformer layers.

17. The computer-implemented method of claim 11, wherein the initial stack of multi-head attention layers comprises a greater number of multi-head attention layers than the final stack of multi-head attention layers.

18. The computer-implemented method of claim 11, wherein a training process that fine-tunes the corresponding language-dependent weights of the plurality of LDA modules while parameters of the causal encoder, the non-causal encoder, and the decoder are held fixed, the training process comprising:
obtaining a plurality of training data sets each associated with a respective native language that is different than the respective native languages of the other training data sets, each training data set comprising a plurality of respective training data samples, each training data sample comprising audio data for an utterance spoken in the respective native language, a language identifier identifying the respective native language, and a corresponding transcription of the utterance in a respective native script representing the respective native language; and
for each of the plurality of LDA modules, fine-tuning the corresponding set of language-dependent weights based only on the training data set that is associated with the respective particular native language.

19. The computer-implemented method of claim 11, wherein each multi-head attention layer in the initial and the final stacks of multi-head attention layers is followed by a corresponding LDA module.

20. The computer-implemented method of claim 11, wherein each corresponding LDA module further comprises:
a layernorm layer;
a down-projection layer,
a Rectified Linear Unit (ReLU) layer,
an up-projection layer; and
a residual connection.
